(19) United States
(12) Patent Application Publication
(10) Pub. No.: US 2012/0324567 A1
(43) Pub. Date: Dec. 20, 2012

(54) Method and Apparatus for Home Network Discovery

(75) Inventors: Paul Couto, Londonderry, NH (US); Jason L. Rogers, Tonganoxie, KS (US); Frederick J. Weidling, Lawrence, KS (US)

(73) Assignee: GENERAL INSTRUMENT CORPORATION, Horsham, PA (US)

(21) Appl. No.: 13/464,449

(22) Filed: May 4, 2012

Related U.S. Application Data
(60) Provisional application No. 61/498,517, filed on Jun. 17, 2011.

(51) Int. Cl. G06F 15/173; G06F 21/00

(52) U.S. Cl. 726/12; 709/224

(57) ABSTRACT

Methods of remotely discovering information of hosts connected to a local area network (LAN) are provided. Electronic communications sent from a gateway behind which the LAN is configured are received by a remote server connected to a wide area network (WAN). The electronic communications include information of a list of hosts connected to the LAN, a log of LAN events, or diagnostic data concerning the LAN. Apparatus for remotely discovering information of hosts or devices connected to a LAN behind a gateway are also disclosed.

### CROSS-REFERENCE TO RELATED APPLICATION

This application claims the benefit under 35 USC §119(e) of U.S. Provisional Patent Application No. 61/498,517, filed Jun. 17, 2011.

### BACKGROUND

A gateway is a device that permits a local area network (LAN) to connect to a wide area network (WAN). For example, the term “residential gateway” has been used to describe a gateway device that connects the LAN within a home to the Internet or other WAN. Thus, devices connected to the LAN, such as desktop computers, laptop computers, notebook computers, tablets, smart phones, gaming consoles, entertainment devices, televisions, set-top boxes, and the like, communicate with the WAN via the gateway. Some examples of gateway devices include cable modems, DSL modems, wireless routers, and Voice over Internet Protocol (VoIP) adapters.

Gateway devices may perform some of the following functions: Internet protocol routing, Network Address Translation (NAT), Dynamic Host Configuration Protocol (DHCP) functions, firewall functions, and LAN connectivity functions. In particular, NAT involves the translation of an Internet Protocol address (IP address) used within one network to a different IP address known within another network. Typically, a gateway device will map its local IP addresses to one or more outside IP addresses and will then unmap the outside IP addresses on incoming packets back into the local IP addresses. This ensures security since each outgoing or incoming request must be processed through a translation process and provides an opportunity to qualify or authenticate the request or match it to a previous request.

Network mapping techniques have been known in connection with the creation of some of the earliest home networks. Conventional local network mapping solutions gather information about devices on a local network, or devices on a public network. However, due to the fact that Network Address Translation (NAT) has been traditionally employed on gateway devices, being able to reach devices that are behind a gateway requires some degree of cooperation with the gateway device. Accordingly, a remote server application is unable to directly “see” any of the devices on a conventional home network. That is, because conventional gateway devices use NAT, Local Area Network (LAN) devices behind the gateway are not visible from the Wide Area Network (WAN) side of the gateway.

The Universal Plug and Play (UPnP) specification provides some ability to gather information for remotely located UPnP endpoints. However, conventional UPnP protocols, such as the UPnP Remote Access Architecture for UPnP Version 2.0 Specification, are only aimed at devices that support UPnP, and not at general collection of information about all devices on the LAN, nor a historical listing of events occurring on the network.

### SUMMARY

This disclosure describes a method of remotely discovering information of hosts connected to a local area network (LAN). Electronic communications sent from a gateway behind which the LAN is configured are received by a remote server connected to a wide area network (WAN). The electronic communications include information of a list of hosts connected to the LAN, a log of LAN events, or diagnostic data concerning the LAN.

This disclosure also describes a method of remotely discovering information of hosts connected to a local area network (LAN) in which electronic communications are transmitted from a gateway behind which the LAN is configured to a remote server connected to a wide area network (WAN). The electronic communications include information of a list of hosts connected to the LAN, a log of LAN events, or diagnostic data.

This disclosure further describes apparatus for remotely discovering information of hosts connected to a local area network (LAN) behind a gateway. A server is configured to receive electronic communications from the gateway of information selected from a list of hosts connected to the LAN, a log of LAN events, and diagnostic data. The server has a visualizer application configured to create a network map for conveying information concerning the hosts connected to the LAN and recent history of events occurring on the LAN.

Still further, this disclosure describes apparatus enabling a server connected to a wide area network (WAN) to remotely discover information of hosts connected to a local area network (LAN). A gateway has a LAN-host discovery module configured to determine hosts connected to the LAN by Address Resolution Protocol (ARP) scans, Dynamic Host Configuration Protocol (DHCP) server information scans, and UPnP scans and configured to compile a log of LAN events including at least one of information concerning when a new host is added to the LAN, when a host is removed from the LAN, an IP address assigned to the host, a new UPnP description file of a host, when a LAN interface is enabled, when a LAN interface is disabled, and when a wireless device fails to authenticate to the LAN. The gateway is configured to transmit electronic communications to the server of information selected from a list of hosts connected to the LAN, the log of LAN events, and diagnostic data.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a block diagram of a system including a network provider, remote server and gateway according to an embodiment.

FIG. 2 is a TLS Handshake Sequence diagram according to an embodiment.

FIG. 3 is a sample gateway LAN host file according to an embodiment.

FIG. 4 is a sample of LAN event log data in the XML format according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

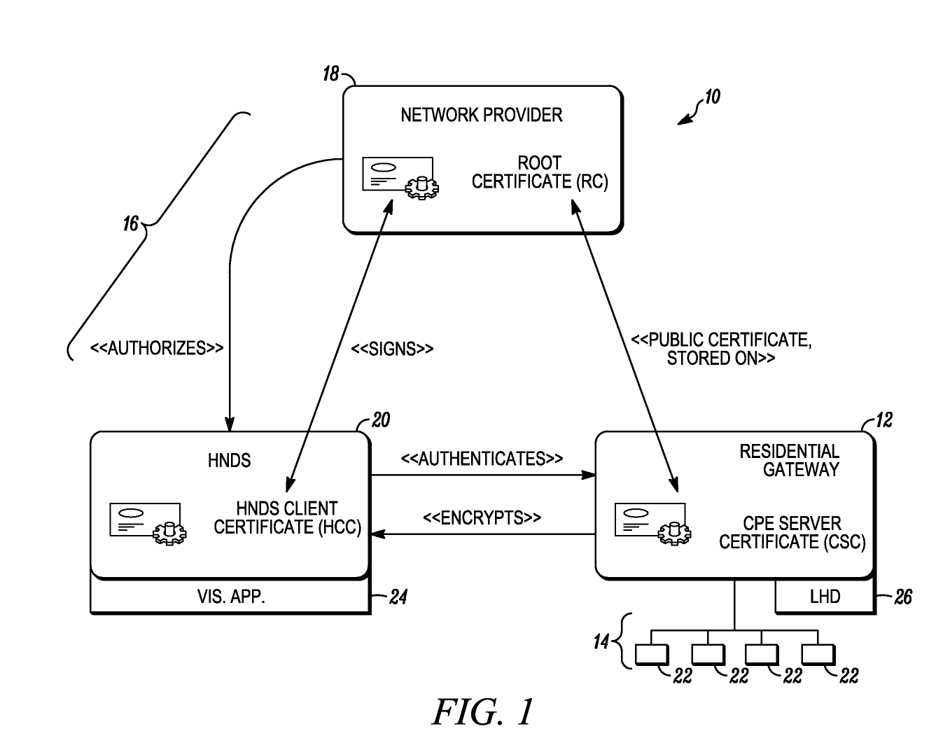

A system 10 including a “Residential Gateway” 12 is shown in FIG. 1. The gateway device 12 may be located at a home or the like and provides a gateway between a LAN 14, such as provided by a home network, and a WAN 16 which provides connections to a “Network Provider” 18 and a Home Network Discovery Server (HNDS) 20. The gateway device 12 performs Network Address Translation (NAT) on outgoing and incoming communications and communicates with various devices 22 connected to the LAN or home network 14. The devices 22 may include various types of computers, lap-tops, tablets, smart phones, wireless devices, televisions, set-top boxes, gaming consoles, control units or the like.

The network provider 18 may be a broadband service provider, such as a Digital Subscriber Line (DSL) provider, a Multiple System Operator (MSO), a cable television provider, an Internet service provider, or the like, and the system 10 is arranged to enable network provider 18 to manage subscriber home networking environments, such as the LAN 14 provided behind the gateway device 12. This remote management is accomplished despite the use of NAT by the gateway device 12.

The Home Network Discovery Server (HNDS) 20 runs a network visualization application 24 in the WAN 16 and must be able to “see” the devices 22 connected to the LAN 14 behind the gateway 12 to perform its intended function. For this purpose, the network visualization application 24 and/or HNDS 20 must be able to request and receive information about the local devices 22 via communications directly with the gateway 12. A Home Network Discovery Protocol (HNDP) is described herein and provides a method of communication between the network visualization application 24 of the HNDS 20 and the gateway device 12.

According to some contemplated embodiments, system 10 may permit a broadband service provider, such as service provider 18, to have real-time visualization of a subscriber home network map of devices, along with the ability to record changes to this network map over a period of time, e.g., over the past day. For purposes of this disclosure, “real-time” includes a level of responsiveness that is sufficiently fast to keep up with the rate of changes or event occurrences on a LAN as well as a level of responsiveness that tolerates a degree of latency or built-in delay, such as occurring within the past day.

A potential benefit of the above referenced visualization application 24 and HNDP is the expected decrease in operations costs achieved by a reduction in the number of support calls from subscribers that may be received. In addition, the duration of such calls should also be reduced. For example, the expanded visibility into the home network 14 by the service provider's help desk agents should quickly and efficiently provide the help desk agents with substantially all information needed to trouble shoot a problem being experienced by a subscriber. In addition, a home network visualization tool may also be useful to the subscriber and enable basic self-service home network management.

The HNDP can support the gathering of a list of LAN devices 22 (including UPnP and non-UPnP devices) along with UPnP device description information for any available UPnP devices, and a log of LAN events (e.g., when devices were added or removed, obtained network addresses, etc.). This information can be used by the network visualizer application 24 on the HNDS 20 to create a graphical network map and to convey a recent history of events and devices on the subscriber's network. As stated above, some embodiments may provide a means for communicating network devices 22 and event histories to the remote network visualizer application 24 so that such information can be made available and used in a real-time display of devices 22 in the subscriber network 14.

The HNDP establishes a method for communicating network map information to the home network discovery server (HNDS) 20 for creating a visual network map. The HNDS 20 is able to receive network map information using the HNDP, and the network visualization application 24 is able to use the HNDP for creating the visual network map. Various embodiments of the HDNP can be applicable to any home network technology which contains a gateway, such as gateway 12 which may be a DSL, DOCSIS, media, or multimedia gateway or other product performing functions similar to a gateway.

The HDNP may be used to communicate details of an end user's local area network (LAN) 14 from the gateway device 12 to a central server (HNDS) 20, for instance, via XML data files. The XML data files may include, for example, a list of hosts or devices 22 on the LAN 14, including details of any available UPnP device descriptions. The XML data files may further include, for example, a list of recent LAN events such as the arrival and departure of devices 22, the reconfiguration of interfaces, when devices renew their IP addresses, and the like. Using XML data files, an application, such as the network visualizer application 24, can recreate the past history of LAN activity.

The HNDP may be used to provide informational event notification and diagnostic data retrieval. The HNDP must also be able to ensure secure transfer of diagnostic data and relevant event notification between the HNDS 20 and gateway 12, ensure a scalable approach to event notification and diagnostic gathering, and allow for new event types and diagnostic logs without requiring a change to the protocol. In addition, the Home Network Discovery Server (HNDS) 20 and/or the visualization application 24 may be a cloud-based Web application that is able to communicate with one or more gateway devices 12 to receive the information provided.

The gateway device 12 may include a LAN host discovery (LHD) module 26 which determines the devices 22 that are connected to the LAN 14. By way of example, the LHD module 26 may perform such a function by using Address Resolution Protocol (ARP) scans, Dynamic Host Configuration Protocol (DHCP) server information, UPnP scans, as well as other means to obtain information concerning the devices 22 and events occurring on the LAN 14.

According to some embodiments, all communications between the HNDS 20 and the gateway device 12 are encrypted using HTTP over TLS (HTTPS RFC 2818) standard. Authentication and authorization may be provided by mutual certificate authentication or by two-way HTTPS.

The HNDP may involve the following interactions between the HNDS 20 and the gateway 12:
The HNDS 20 acquires the IP address, port, and credentials for a specific gateway 12 from a database of subscribers of the service provider 18;
The HNDS 20 requests LAN host table information, which contains information of all devices 22 discovered on the local network 14 and Uniform Resource Locators (URLs) to UPnP device-description files for LAN-connected devices that support UPnP;
The HNDS 20 uses the device-description URLs to retrieve the UPnP information for each available device; and
The HNDS 20 requests LAN event log information from the gateway 12 and the gateway 12 responds immediately if log information is available, and if the log is empty, the gateway 12 returns log information as soon as it becomes available.

In accordance with some embodiments, when the HNDS 20 receives the event log, it immediately sends another request for the purpose of ensuring that the gateway 12 will return new logs as soon as they become available. As a result of this process, events may be grouped together. The poll cycle may be made sufficiently frequent to permit events to be returned in near real time.

The HNDS 20 may request the LAN host table as often as necessary. The HNDS 20 may also force a re-scan of the local network 14 to determine if new devices are present or if old devices have left the network 14. In some embodiments, the format of the LAN host table and the LAN events may be XML over HTTPS. In a further embodiment, events sent from the gateway 12 and requests for diagnostic event logs are stateless, meaning they will never require knowledge of previous events on the channel. The gateway 12 may be free to send any event over the channel, avoiding a subscription model when the HNDS 20 connects to the gateway 12.

### EXAMPLE

An illustrative embodiment of an HNDP is described below. As discussed above, the Home Network Discovery Protocol (HNDP) is intended to provide informational event notification and diagnostic data retrieval. The goals of this protocol are to ensure secure transfer of diagnostic data and relevant event notification, ensure a scalable approach to event notification and diagnostic gathering, and allow for new event types and diagnostic logs without requiring a change to the protocol. According to this example, the Home Network Discovery Server (HNDS) is provided as a cloud-based Web application that communicates with a population of gateway devices. The same HNDS may also communicate with the gateway devices for management and configuration, but this is not required. In addition, each gateway will have a LAN host discovery (LHD) module that is able to determine the devices that exist on the LAN by using ARP scans, DHCP server information, and like techniques.

The base protocol used for communications between the HNDS and gateways is XML over two-way HTTPS. The following HTTP status codes can be used to indicate success or failure of requests generated by the HNDS to the gateway. If the common name (CN) specified in the HNDS client certificate (HCC) is not trusted, the gateway terminates the connection by returning an HTTP 403 status code with an empty body. If the request is authenticated but the URL is not recognized or not supported, the gateway returns an HTTP 501 status code indicating that the device does not support the requested service. If the request fails for any other reason, the gateway returns an HTTP 500 status code with a diagnostic message indicating the cause. If the gateway already has the maximum concurrent connection, the gateway may refuse to accept additional socket requests, and if the gateway cannot service a request due to load or resource constraint, the gateway returns an HTTP 503 status code with a diagnostic message indicating the cause. See Table 1 below for a summary of status codes.

TABLE 1

| HTTP | |
|---|---|
| Status Code | Description |
| 200 OK | The request was successfully processed. |
| 403 Forbidden | The CN in the HNDS client certificate is not |
| | authorized. |
| | The gateway may also terminate connections in this |
| | case by signalling failure at the TLS layer during |
| | negotiation. |
| 500 Server | An internal gateway error. |
| Error | |
| 501 Not | The gateway does not support the requested resource. |
| Implemented | |
| 503 Service | The gateway already has the maximum number of |
| Unavailable | connections it accepts open, or the gateway is under too |
| | much load to service the current request. |
| | If the maximum number of connections is open, the |
| | gateway may also refuse the TCP connection. |

In communications sent from the gateway to the HNDS, the communications include all HTTP headers marked as required in RFC 2616 and includes a unique device identifier header. The format of this header may be as specified below: “X-HNDP-DeviceId: <OUI><ProductClass><SerialNumber>”, where OUI, ProductClass, and SerialNumber are replaced with the device appropriate values as shown, for instance, in Table 2.

TABLE 2

| Field | Description |
|---|---|
| OUI | Organizationally Unique Identifier, as defined by the |
| | IEEE. |
| ProductClass | An identifier for the class of devices within which the |
| | SerialNumber is unique. |
| SerialNumber | The number which uniquely identifies the device within |
| | a given OUI and ProductClass. |

Communications between the HNDS and the gateway are encrypted using the HTTP over TLS (HTTPS RFC 2818) standard. Authentication and authorization are provided by mutual certificate authentication or two-way HTTPS. The gateway terminates connections that do not provide a client certificate signed by a well known root certificate.

The above described formulation results in three certificates, two of which are stored on the gateway and one of which is stored on the HNDS. The three certificates include a Root Client Certificate (RC), a HNDS Client Certificate (HCC), and a CPE Server Certificate (CSC). As an example, FIG. 1 depicts a Certificate Responsibility diagram. The RC is stored on the gateway and the private key is stored by the network provider and only used for signing HCCs. The HCC certificate and private key are stored on the HNDS, and the CSC and private key are stored on the gateway.

The Root Client Certificate (RC) is owned by the network provider. The network provider uses the private key from the RC to sign the HNDS client certificates. The use of a common name (CN) allows the provider to revoke an HNDS' client certificate by changing the accepted CN in the gateway's data model. To most efficiently verify client certificates, the RC for signing client certificates is preconfigured on the gateway. This certificate will be used to sign HNDS client certificates used across devices from multiple vendors. The RC is the same for all devices supporting the protocol in a service provider's network. Using an embedded root certificate removes the requirement to access a certificate authority; however, it limits certain features of a certificate authority, such as certificate revocation. To more strictly control the set of active certificates, a trusted common name (CN) may be configured on the gateway. When this option is set, the gateway verifies both that the HNDS client certificate is signed by the root certificate and that the client certificate's CN matches the configured value.

The HNDS Client Certificate (HCC) is owned by the HNDS implementing party. The HCC is signed by the RCC. This certificate is presented to the gateway in response to a Client Certificate Request. This mechanism provides authentication of the HNDS to the gateway and ensures that the HNDS has been authorized to retrieve the requested information.

The CPE Server Certificate (CSC) is the gateway's HTTPS server certificate. Due to the volatility of the gateway's WAN IP, it is expected that the common name of the CSC may not match the device's IP address. The HNDS accepts HTTPS connections regardless of whether the CN matches the gateway's true address. This allows the gateway's IP address to vary without requiring a new CSC to be generated. Due to the lack of CN, the CSC only provides encryption and not authentication of the device. For additional authentication the network provider may require that the CSC be signed by a well known certificate authority with a pre-specified CN. If this level of security is desired, the HNDS verifies that the CSC is properly signed with the well-known common name.

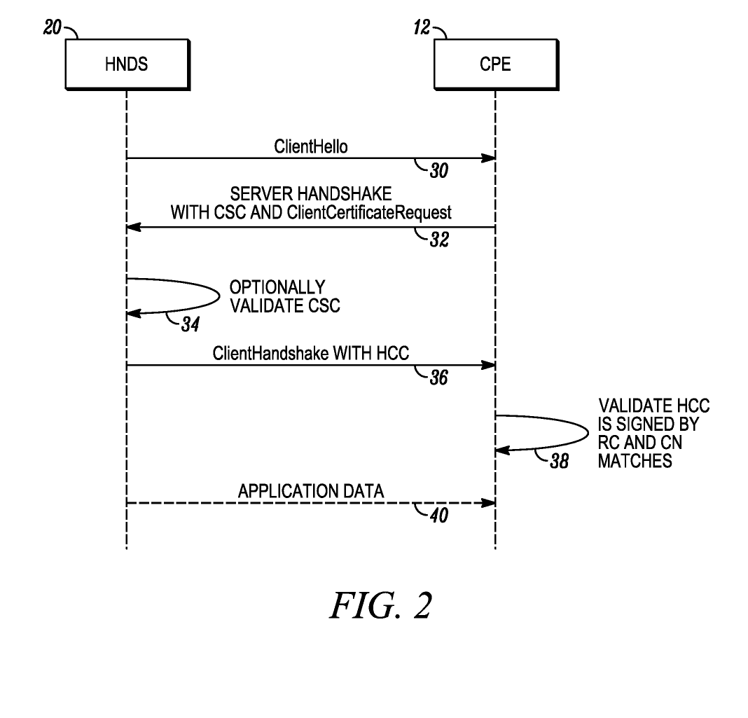

FIG. 2 depicts a TLS Handshake Sequence diagram, in accordance with this example. The HNDS 20 sends a “Client Hello” request to the gateway or other customer premises equipment (CPE) 12 in step 30. Thereafter in step 32, the gateway 12 responds to the HNDS 20 with a “Server Handshake” providing the CSC and a “Client Certificate Request”. The HNDS 20 validates the CSC in step 34 and responds in step 36 with a “Client Handshake” providing the HCC. In step 38, the gateway 12 validates that the HCC is signed by RC and that the CN matches. If validation is successful, the gateway 12 sends the requested data in step 40 concerning the devices connected to the LAN and event log.

The HNDP allows for the definition of multiple services. A service represents a logical group of functionality rooted at a well known URI. LAN host discovery and event notification provide examples of such services. A strict definition for service implementation is intentionally omitted to allow services to be optimized for the given functionality.

An event delivery service allows low latency notifications of events on the gateway. A technique referred to as long polling can be used by which the gateway holds open the HTTP request without sending a response until an event of interest is generated. This format may be chosen because no additional subscription model is required. For instance, when the HNDS is connected to the event service, the HNDS is subscribed, when it is not connected, it is not subscribed. This format may also be chosen because the gateway is always an HTTP server and there is no requirement for separate channels with separate data and security issues. In addition, as an HTTP client, the HNDS must reach out to the gateway in order to receive events. This reduces the chances of the HNDS being overloaded by receiving an unexpectedly large number of concurrent events.

The LAN event service may be exposed at “/lanevents”. For instance, a request for “https://{WAN IP}:{MANAGEMENT PORT}/lanevents” may contain the parameter “listen-since=xsd:dateTime” with second precision. If the listen-since parameter is present, the gateway returns all events from its LAN event log that occurred after the listen-since time. If no events have occurred since the time specified in listen-since, the gateway waits until an event is generated, the requestor closes the socket, or the maximum timeout specified in the “Protocol Parameter Values” has been exceeded. If the listen-since parameter is not present, the gateway returns all events from its LAN event log. If the listen-since parameter is not present and the gateway has no events in its LAN event log, the gateway waits until an event is generated, the requestor closes the socket, or the maximum timeout specified in the “Protocol Parameter Values” has been exceeded. If the connection is closed, the HNDS may repeat the request as often as needed as long as the number of concurrently open sockets does not exceed the limits of the gateway.

The LAN event service does not directly define events; rather, it only provides a mechanism for relaying events. Other services may use the event service for relaying real time updates to the HNDS.

The event format contains a timestamp and a key. The key is used to indicate the expected format of the XML contained within the event body. As an example, the gateway can return LAN event log data in the following XML format:

<lanevents>

<event Timestamp=“2010-12-08T21:21:47Z”
Key=“lanhosts:hostAdded”>

<!-- Format specified by Key -->

</event>

</lanevents>.

Turning to a LAN Host Discovery service, the HNDP protocol involves various interactions between the HNDS and gateway. For example, the HNDS may acquire the IP address, port, and credentials for a specific gateway from a database of subscribers, and then the HNDS may request LAN host table information from the gateway. This table contains URLs to UPnP device-description files for LAN-connected devices. The FINDS uses the device-description URLs to retrieve the UPnP information for each available device. The FINDS may also request LAN event log information from the gateway, and the gateway responds immediately if log information is available. If the log is empty, the gateway may be set to return log information as soon as it becomes available. When the HNDS receives the event log, it may immediately send another request for event log information for purposes of ensuring that the gateway will return new logs as soon as they become available. As a result of this process, events may be grouped together; however, the poll cycle can be sufficiently frequent so that events can be returned in near real-time, if desired. The HNDS may also request the LAN host table as often as necessary.

The format of the LAN host table and the LAN events may be in the form of XML over HTTPS. Events sent from the gateway and requests for diagnostic event logs can be stateless, meaning that they never require knowledge of previous events on the channel. The gateway is free to send any event over the channel, avoiding a subscription model when the HNDS connects to the gateway. The HNDS filters events as needed; however, it is not expected that there will be more than a few dozen types of events.

A LAN-Host Discovery (LHD) table will be populated by the gateway with data gathered from several sources. First, an ARP scan may find any statically configured hosts on the local LAN network. Second, information from the DHCP server will be used to populate devices that have been given leases locally. Information from the DHCP server will provide information such as the start time of the current lease and other host information that cannot be gathered with a simple ARP scan. For the purpose of this protocol, additional information will be added to the LAN Host Discovery table for any devices that may contain UPnP presence. To gather this information, the gateway will act as an UPnP control point and send a periodic Simple Service Discovery Protocol (SSDP) M-Search message to discovery-available UPnP root devices. This query is conducted after the basic information in the LHD table has been populated with the ARP scan and DHCP server information.

UPnP discovery will allow for the following information in the LHD table: UUID of the UPnP device, which is found in the Unique Service Name (USN) information in the SSDP Notify packet; URL of the UPnP device description, which is found in the Location information in the Notify packet (this URL will be translated to a URL local to the gateway to allow proxy access); and max-age information, which will be used to determine how often the gateway should refresh its cached device description information.

The direct URL of the UPnP device description will not be passed to the HNDS client. Instead, a gateway WAN URL will be returned to the HNDS. The gateway may store this as a temporary file on the file system, or it may proxy requests from the server to the UPnP root device when the HNDS requests the descriptor. The format of the URL is not specified, although it is recommended that the URL include the UPnP root device UUID in order to ensure uniqueness across all LAN devices. If space and implementation allows, the gateway will maintain a record of these files even if the device leaves the network. This will allow the HNDS to retrieve more information about the devices on the user's network even when they are not currently online.

After the HNDS retrieves the entire LAN host table from the gateway, the HNDS will be able to request the individual URL for the UPnP description of any LAN network device. The HNDS is responsible for downloading these files and parsing the information contained within, which will reduce the burden on the gateway. This configuration will also reduce the need for further gateway changes if the display of additional fields in these descriptions is needed by the visualizer application of the HNDS.

As an example, the HNDS may request the LAN Host Table information for the gateway by making a request to: “https://{WAN-address}:{management-port}/lanhosts”. The returned file may include information about all current devices on the LAN network. Any devices that are UPnP endpoints will have additional information, including the URL (local to the gateway) from which the UPnP device description information can be retrieved. The HNDS will access these URLs and parse out the required information.

Once a connection is established, the HNDS can request the LAN event log from the gateway. The HNDS may use this log to obtain further diagnostic information for devices on the LAN. While the connection is active, the gateway can send events to the HNDS when clients join or exit the LAN network. This allows efficient polling of small changes to the state of the network.

The HNDS may explicitly request an on-demand rescan of the devices connected to the LAN by calling the URL: “https://{WAN-address}:{management-port}/lanhosts-scan”. If the request is accepted, the device immediately returns an HTTP 200 message. However, to prevent excessive resource usage, the gateway may require a certain amount of time to elapse before it accepts a subsequent call to scan. If this interval has not yet passed, the gateway may return an HTTP 503 message. When there is an active connection to the event log service, the gateway may also scan the network autonomously.

With respect to format, the LAN hosts service may return an XML document rooted with the <hosttable> element. This element may have two child elements, <interfaces> and <ethernet>. The <interfaces> element includes information for all LAN interfaces available on the gateway and may contain one or more <interface> elements with one or more configuration elements. Each interface may define a Name, Status, GatewayAddress, and SubnetMask, for instance, as shown below in Table 3.

TABLE 3

| Property | Description |
|---|---|
| Name | The unique name for the interface. |
| Status | ENABLED or DISABLED. |
| GatewayAddress | The IP address of the interface's gateway. |
| SubnetMask | The subnet mask for the interface. |

The interface may contain one <dhcp> element, one or more <ethernet> elements, and one or more <wireless> elements. Table 4 provides an example of such a structure.

TABLE 4

| Element | Property | Description |
|---|---|---|
| Dchp | | Describes the DHCP configuration for |
| | | the interface. |
| | State | ENABLED or DISABLED or RELAY |
| | | indicating the DHCP state. |
| | StartAddress | The starting address range for the |
| | | DHCP server. Required only if State is |
| | | ENABLED. |
| | EndAddress | The ending address range for the |
| | | DHCP server. Required only if State is |
| | | ENABLED. |
| Ethernet | | Describes the Ethernet interface. |
| | Ports | The names of the ports on the |
| | | interface. |
| Wireless | Port | The name of the port as referenced by |
| | | the host's entries. |
| | Status | UP or DOWN, indicating whether the |
| | | interface is broadcasting or not. |
| | TR-098 | Optional. All parameters from the TR- |
| | WLANConfigura- | 098 WLANConfiguration element may |
| | tion | be specified. |
| | Parameters | |

The <hosts> section may contain entries for all currently connected hosts, as well as recently disconnected hosts. When the HNDS requests the host table XML file, the gateway generates the contents based on the current LAN host table it maintains. The items identified in Table 5 may be returned for each available host.

TABLE 5

| Property | Description |
|---|---|
| IpAddr | The LAN IP address of the device. |
| MacAddr | The MAC address of the connected interface. |
| HostName | The host name as reported in DHCP headers, if |
| | specified. |
| Type | The LAN IP address source, either STATIC or DHCP. |
| State | The connection state of the device at the time of the last |
| | scan, either ONLINE or OFFLINE. |
| Interface | The name of the interface to which the device is |
| | connected, as specified in the interface's Name |
| | property. |
| Port | The name of the port to which the device is connected. |
| LastUp | The last time the device was marked as ONLINE. |

Each host may also contain zero or more UPnP root device entries. The UPnP rootDevice tag is contained in an UPnP tag. Each rootDevice entry contains the UUID of the UPnP device, the URI at which the gateway is exposing the UPnP descriptor, and the URI at which the gateway is exposing the icon, if specified and supported. See Table 6. The URI is relative to the protocol root and carries the same security constraints. In addition to the LAN host table, information about the current LAN interfaces may also included in this file.

TABLE 6

| Property | Description |
|---|---|
| UUID | The UUID of the UPnP root device. |
| DescURI | The URI to the UPnP root device descriptor. |
| IconURI | Optional. The URI to the UPnP icon, if specified. |

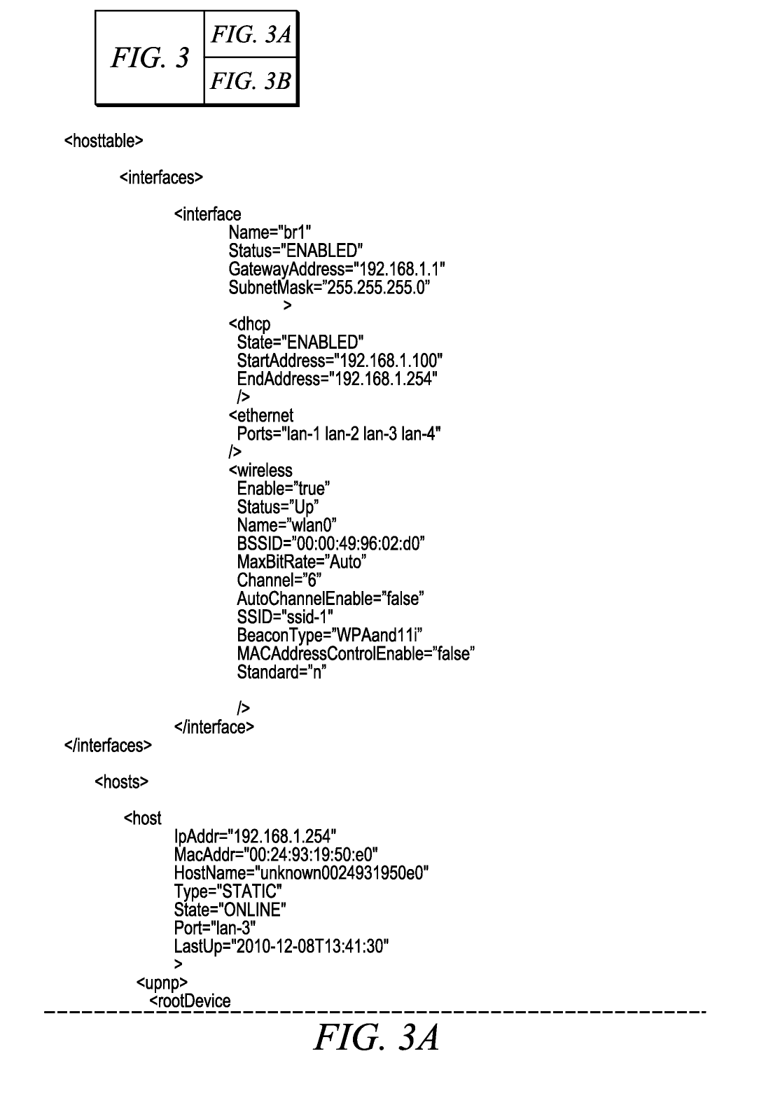

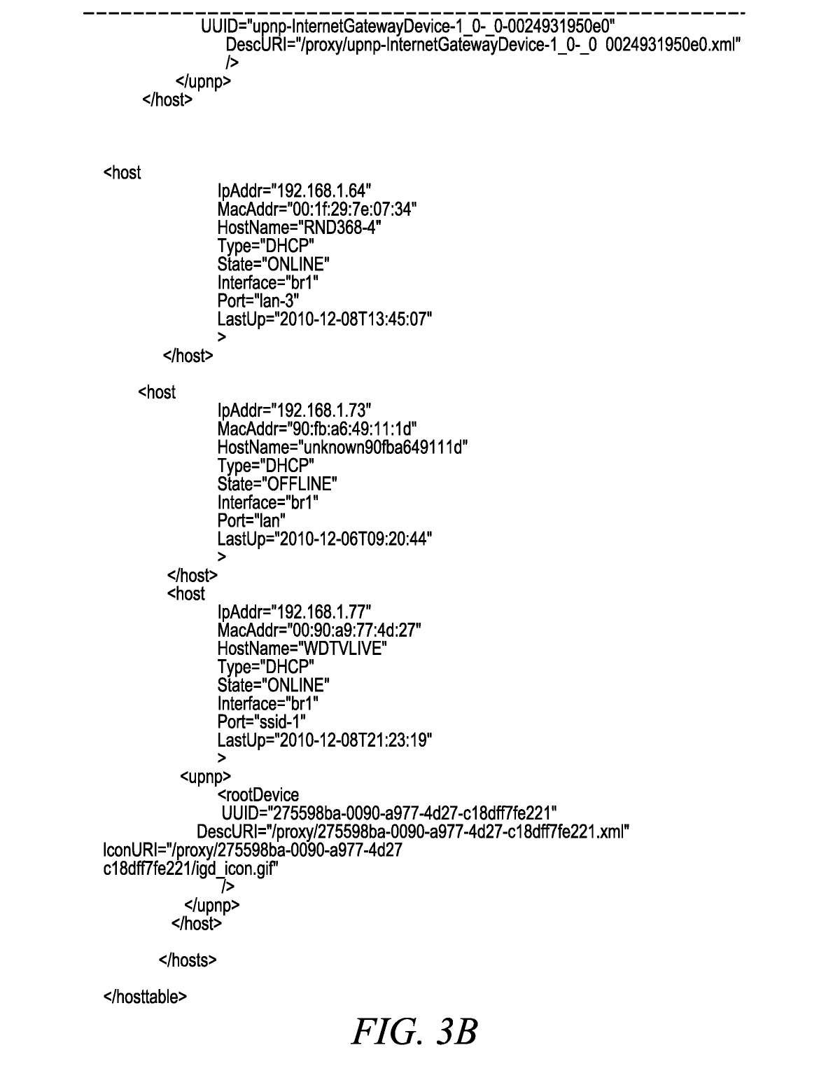

By way of example, a sample gateway LAN host file may be as shown in FIG. 3.

Certain resources from LAN devices may be exposed to the HNDS by the gateway. These resources may be exposed at the URL: “https://{WAN-address}:{management-port}/proxy/{Device-UUID}”. These files may be protected with the same mutual HTTPS authentication scheme used by the rest of the protocol. The gateway may download and store any static content in order to make it available when the LAN device is offline. The file available at the DescURI includes the contents of the UPnP device description file from the LAN device. The gateway does not modify the contents of the descriptor file, and the HNDS may parse the file to extract any necessary information. The gateway may expose any of the image files specified in the UPnP descriptor. The accepted file formats are as defined by the UPnP specification. The gateway may proxy other resources as defined by a vendor.

A separate diagnostic log may be created to record the details of LAN host activities. This log will record the last 24 hours of activity. The HNDS is able to request the contents of the entire log, isolating it from the internal representation of the data, as specified by the Event Service. This log can be formatted in an XML format, such as specified below.

Events that may be logged may include the following: host arrival (a new host added to the table through either an ARP scan or DHCP); host departure/timeout from host table (the host has been removed from table through a timeout or DHCP lease expiration); and host received IP address (DHCP initial grant or lease renewal). The following events may also be logged: updated UPnP information from host (a new UPnP description file has been added or data in an existing file has been updated); LAN Interface enabled (a LAN interface has been reconfigured as “enabled”); LAN Interface disabled (a LAN interface has been reconfigured as “disabled”); and wireless client failed to authenticate (failure may be due to a misconfigured client, or the client may have been denied because its MAC address is blacklisted). All logs include the MAC address of the particular host for tracking purposes.

To facilitate event parsing by the HNDS, the format of the log is fixed to the following list of entries, which correspond to the events in the previous section. Each event name is prefixed with LANhosts to indicate that the event was generated by the LAN hosts service, and each event contains a partial host element as defined in the LANhosts section. Every entry includes a MAC address. Other properties related to the event may also be included. See Table 7 for event keys.

TABLE 7

| Event Key | Description |
|---|---|
| lanhosts:hostAdded | A new host connected at the PHY layer. |
| | This event may be buffered up to 1 second |
| | in order to combine it with a DHCP |
| | address assigned event. |
| lanhosts:hostRemoved | A host disconnected from the PHY layer. |
| lanhosts:hostAddress | A new IP address was assigned to a device |
| | with DHCP, or a new IP address was report- |
| | ed by a device with static or DHCP relay. |
| lanhosts:hostUPnP | The UPnP information associated with a |
| | device was updated. |
| lanhosts:hostAuthFailed | Wireless client authentication failed, or |
| | MAC filtering caused the Ethernet layer |
| | to refuse. |
| lanhosts:hostErrors | The errors on a given port exceeded a |
| | predefined level. |
| lanhosts:interfaceEnabled | An interface was enabled. |
| lanhosts:interfaceUpdated | Optional. Notifies the HNDS that the |
| | interfaces section of the host table |
| | needs to be refreshed. |
| | It is recommended this event be |
| | generated when wireless SSIDs or |
| | encryption are modified, or when |
| | there is a significant change to |
| | the structure of the home network. |
| lanhosts:interfaceDisabled | An interface was disabled. |

The events hostAdded, hostRemoved, hostAddress, hostUPnP, hostAuthFailed, and hostErrors contain a host XML element as defined above. The host element contains the LAN host MAC address, and any information that was changed with the event. In Table 8 provided below, properties marked “Required” are populated when the associated event is sent. For the fields marked “If Available”, the properties are populated if the gateway can determine them. Optional properties may or may not be included at the gateway implementer's discretion.

TABLE 8

| Property | hostAdded | hostRemoved | hostAddress | hostUPnP | hostAuthFailed | hostErrors |
|---|---|---|---|---|---|---|
| MacAddr | Required | Required | Required | Required | Required | Required |
| IpAddr | If Available | Optional | Required | Optional | Optional | Optional |
| Hostname | If Available | Optional | If Available | Optional | Optional | Optional |
| Type | If Available | Optional | Required | Optional | Optional | Optional |
| State | Optional | Optional | Optional | Optional | Optional | Optional |
| Interface | Required | Optional | Optional | Optional | Optional | Optional |
| Port | Required | Optional | Optional | Optional | Optional | Optional |
| LastUptime | Optional | Optional | Optional | Optional | Optional | Optional |
| UUID | Optional | Optional | Optional | Required | Optional | Optional |
| DescURI | Optional | Optional | Optional | Required | Optional | Optional |

The events interfaceEnabled, interfaceUpdated, and interfaceDisabled contain an interface element that contains the name property and may contain any other properties which are valid for the interface element.

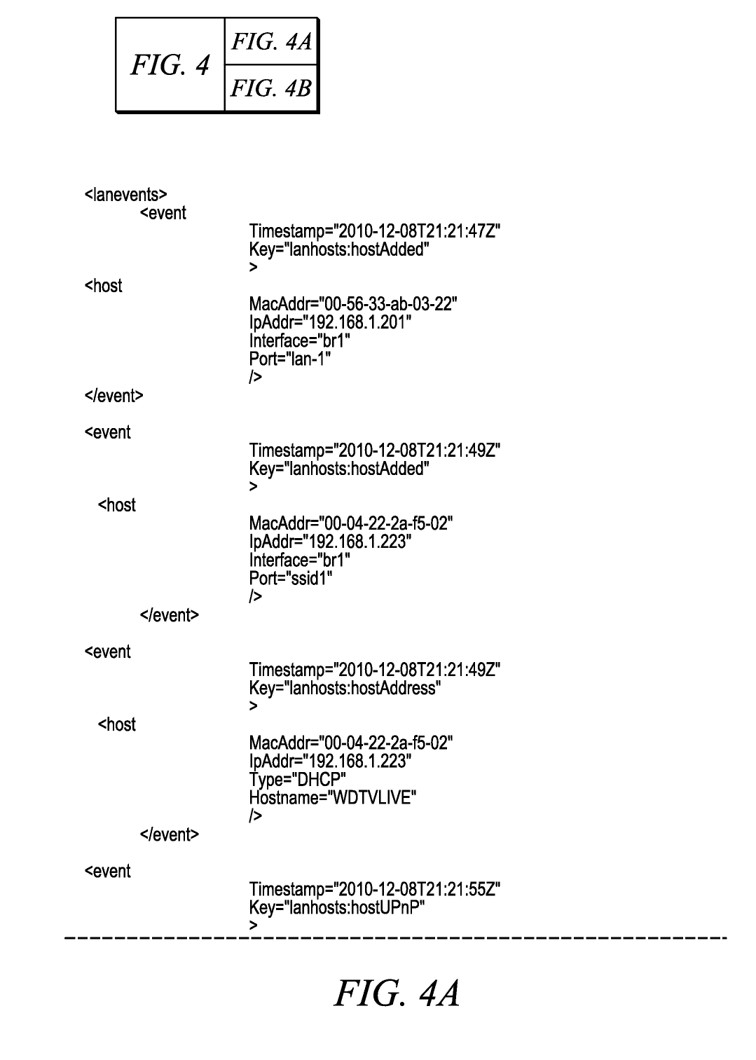

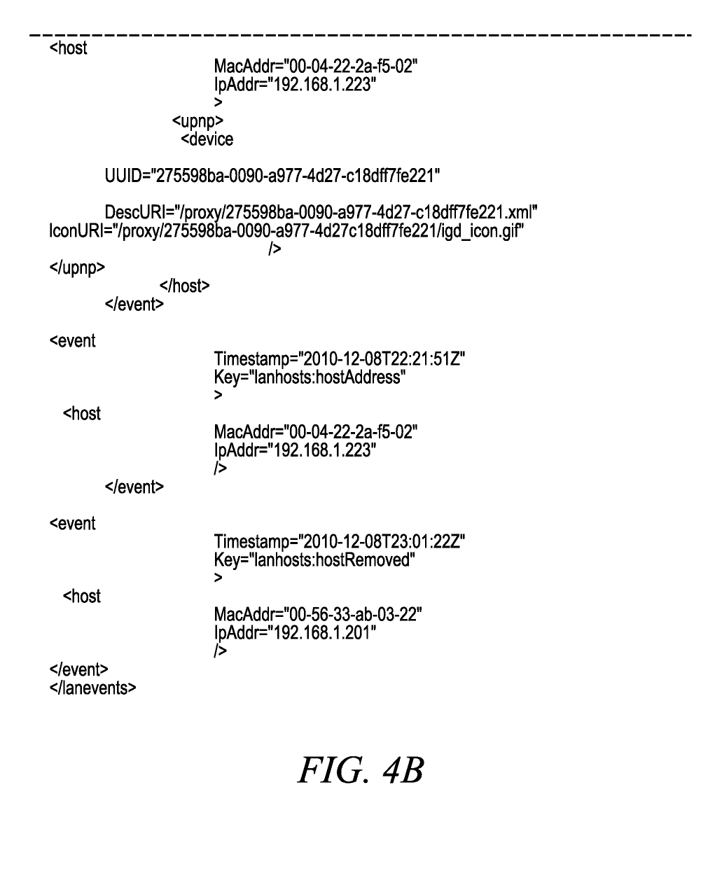

As an example, the gateway may return LAN event log data in the XML format shown in FIG. 4.

Parameter values provided in Table 9 provide examples of such values that may be used with the HNDP protocol.

TABLE 9

| Parameter | Value | Description |
|---|---|---|
| Management Port | 49950 | The standard port for the protocol. |
| Event Timeout | 300 seconds | The maximum duration between a |
| | | request by the HNDS for new |
| | | events and the HTTP response. |
| Maximum Event | 5 seconds | The maximum amount of time |
| Latency | | between when a device recognizes |
| | | an event and when the HTTP |
| | | response is sent to an HNDS |
| | | listening to the event log. |
| Minimum Event | 100 entries | The minimum number of historical |
| Log Size | | event log entries the CPE must |
| | | retain. |
| Minimum | 2 | The gateway must accept at least |
| Concurrent | | this number of concurrent HTTPS |
| Connections | | connections; the HNDS may expect |
| | | no more than this number of |
| | | concurrent HTTPS connections. |
| Maximum Device | 1 minute | The gateway must detect devices |
| Detection Latency | | with static IP addresses and devices |
| | | disconnecting from the network |
| | | within this time period. |

In order to support devices with limited CPU or lack of long term storage, the protocol may incrementally support different levels of functionality. The devices may also drop down to lower levels of support in order to give higher priority to current traffic, or if the network is flooded with events that would otherwise cause LAN traffic to be adversely affected. By way of example, the levels may include a Basic Level of Protocol Support (Level 1), an Event Support Level (Level 2), and a Long Term Storage Support Level (Level 3).

With respect to a Basic Level of Protocol Support (Level 1), all gateways which implement this protocol must support two-way HTTPS authentication. The /lanhosts and /lanhosts-scan operations must be supported, and the gateway must retrieve as many of the documented properties as possible. The HNDS must be able to handle any missing properties other than MAC address.

With respect to Event Support (Level 2), the gateway must be able to report incremental changes to the LAN hosts as events so that the HNDS can efficiently show updates to the home network in real-time. However, a gateway which does not support the event protocol may return a status message with an HTTP 501 status code to indicate this functionality is not supported.

For Long Term Storage Support (Level 3), the gateway must store the logged events to a file that is persistent across device reboots to thereby fully support a historical view of the user's home network. However, a gateway may partially support the protocol without this storage requirement.

The HNDP event model may support restrictions by host. In this case, when changes to the restrictions are made, the body of the event contains a <restrictedhost>. Information about restricted networks is contained in a <restrictedhost> element which may specify Type, MacAddr, and Enforcement as indicated below in Table 10. The <restrictedhost> also can specify IpAddr if the device has been granted an IP address.

TABLE 10

| Property | Description |
|---|---|
| Type | The type of restriction enforced. NONE, |
| | GUESTNETWORK, BLACKLIST, or |
| | TIMEOFDAY. An event will only contain |
| | Type = “NONE” when it has a certain restriction |
| | (such as BLACKLIST) removed, and the gateway is |
| | notifying the HNDS via a restriction:updated event. |
| IpAddr | The IP address of the restricted host. |
| MacAddr | The MAC address of the restricted host. |
| Enforcement | The current enforcement status of the restriction. |
| | NONE, INTERNETONLY, or BLOCKED. Where |
| | NONE indicates that the host currently has full |
| | access, INTERNETONLY indicates the host |
| | currently has internet access but not local network |
| | access, and BLOCKED indicates that the host has no |
| | access to internet or the local network. |

All events generated in relation to changes in Internet and network access granted to hosts have the following criteria: each event key is prefixed with restriction to indicate that the event was generated in relation to host network access restriction; and each event contains a full <restrictedhost> element. The defined events capture when a device is added to or removed from a certain set of restrictions (restriction:updated), when the enforcement state changes due to time of day changes or usage being exceed (restriction:enforcementChange), and when a device joins the network with a restriction in effect (restriction:enforced). See Table 11 for a summary.

TABLE 11

| Event Key | Description |
|---|---|
| restriction:updated | When a new host is added, removed, or |
| | moved to a new type of restriction. |
| restriction:enforcementChange | When the enforcement status changes, |
| | such as going from BLOCKED to NONE |
| | because of a time of day change. This |
| | event only needs to be sent if the device is |
| | actively connected |
| restriction:enforced | Sent when a device connects and that |
| | device has a restriction other than NONE. |

The above gateway devices, servers, modules and the like for carrying out the above methods and protocol can physically be provided on a circuit board or within another electronic device and can include various processors, microprocessors, controllers, chips, disk drives, and the like. It will be apparent to one of ordinary skill in the art that the modules, processors, controllers, units, and the like may be implemented as electronic components, software, hardware or a combination of hardware and software. The methods described above are not limited to gateway devices or the combinations of devices disclosed above.

Specific embodiments have been described above. However, one of ordinary skill in the art appreciates that various modifications and changes can be made without departing from the scope of these embodiments as defined in the appended claims. Accordingly, the specification and figures are to be regarded in an illustrative rather than a restrictive sense, and all such modifications are intended to be included within the scope of the appended claims.

We claim:

1. A method of remotely discovering information of hosts connected to a local area network (LAN), comprising the step of receiving electronic communications with a remote server connected to a wide area network (WAN) from a gateway behind which the LAN is configured, said electronic communications including information selected from a group consisting of a list of hosts connected to the LAN, a log of LAN events, and diagnostic data.

2. The method according to claim 1, wherein the information includes the log of LAN events, and wherein the LAN events are selected from a group consisting of when hosts were added to the LAN, when hosts were removed from the LAN, when interfaces were reconfigured, and when hosts renewed network addresses.

3. The method according to claim 1, wherein the information includes the list of hosts connected to the LAN, and wherein the list includes information of all devices connected to the LAN including devices that support Universal-Plug-and-Play (UPnP) and devices unable to support UPnP.

4. The method according to claim 3, wherein the gateway is a residential gateway, the LAN is a home network, and the devices are selected from a group consisting of computers, lap-top computers, tablet computers, wireless devices, smart-phones, gaming consoles, and entertainment devices.

5. The method according to claim 3, wherein the list of hosts connected to the LAN includes a Uniform Resource Locator (URL) to an UPnP device-description file for each device connected to the LAN that supports UPnP.

6. The method according to claim 5, further comprising the step of automatically retrieving information with the remote server from a remote source concerning the devices that support UPnP with use of the URLs provided by the gateway in the electronic communications.

7. The method according to claim 1, wherein the electronic communications are provided as XML data files and are encrypted.

8. The method according to claim 1, wherein the electronic communications are authenticated and authorized between the gateway and remote server by at least one of mutual certificate authentication and two-way HTTPS authentication.

9. The method according to claim 1, further comprising the step of creating a network map for conveying information concerning the hosts connected to the LAN and a recent history of events occurring on the LAN, said creating step being performed by a remote visualizer application running on the remote server.

10. The method according to claim 8, wherein the network map is a graphical network map produced in real-time.

11. The method according to claim 1, further comprising the step of sending an electronic communication from the remote server to the gateway device to request at least one of the list of hosts on the LAN, the log of LAN events, and a re-scan of the LAN by the gateway to discover if hosts have been added or removed from the LAN.

12. The method according claim 1, further comprising the step of acquiring IP address, port and credentials of the gateway with the remote server from a database of a service provider to which the LAN is a subscriber.

13. The method according to claim 11, wherein the service provider is selected from a group consisting of a broadband service provider, a Digital Subscriber Line (DSL) provider, a Multiple System Operator (MSO) provider, a cable television provider, and an Internet service provider.

14. A method of remotely discovering information of hosts connected to a local area network (LAN), comprising the step of transmitting electronic communications from a gateway behind which the LAN is configured to a remote server connected to a wide area network (WAN), said electronic communications including information selected from a group consisting of a list of hosts connected to the LAN, a log of LAN events, and diagnostic data.

15. The method according to claim 14, further comprising the step of determining the hosts connected to the LAN by at least one of Address Resolution Protocol (ARP) scans, obtaining Dynamic Host Configuration Protocol (DHCP) server information, and UPnP scans performed by the gateway.

16. The method according to claim 14, further comprising the step of compiling the log of LAN events including at least one of information concerning when a new host is added to the LAN, when a host is removed from the LAN, an IP address assigned to the host, a new UPnP description file of a host, when a LAN interface is enabled, when a LAN interface is disabled, and when a wireless device fails to authenticate to the LAN, wherein said compiling step being performed by the gateway.

17. The method according to claim 14, further comprising the step of receiving a request with the gateway via an electronic communication sent from the remote server, wherein, after receiving the request, the gateway performs at least one of transmitting the list of hosts on the LAN to the remote server, transmitting the log of LAN events to the remote server, and re-scans the LAN to discover if hosts have been added or removed from the LAN.

18. Apparatus for remotely discovering information of hosts connected to a local area network (LAN) behind a gateway, comprising a server configured to receive electronic communications from the gateway of information selected from a group consisting of a list of hosts connected to the LAN, a log of LAN events, and diagnostic data, said server having a visualizer application configured to create a network map for conveying information concerning the hosts connected to the LAN and a recent history of events occurring on the LAN.

19. Apparatus according to claim 18, wherein the server is configured to send an electronic communication to the gateway to request at least one of the list of hosts on the LAN, the log of LAN events, and a re-scan of the LAN by the gateway to discover if hosts have been added or removed from the LAN.

20. Apparatus enabling a server connected to a wide area network (WAN) to remotely discover information of hosts connected to a local area network (LAN), comprising a gateway having a LAN-host discovery module configured to determine hosts connected to the LAN by at least one of Address Resolution Protocol (ARP) scans, Dynamic Host Configuration Protocol (DHCP) server information scans, and UPnP scans and configured to compile a log of LAN events including at least one of information concerning when a new host is added to the LAN, when a host is removed from the LAN, an IP address assigned to the host, a new UPnP description file of a host, when a LAN interface is enabled, when a LAN interface is disabled, and when a wireless device fails to authenticate to the LAN, and said gateway being configured to transmit electronic communications to the server of information selected from a group consisting of a list of hosts connected to the LAN, the log of LAN events, and diagnostic data.
